(19) United States
(12) Patent Application Publication
(10) Pub. No.: US 2012/0187808 A1
(43) Pub. Date: Jul. 26, 2012

(54) COMPOSITE COUNTERTOP MODULES WITH INTREGRAL BUILT-UP EDGE AND METHOD OF MAKING COUNTERTOPS

(76) Inventor: Andrew Griffith, Kent, WA (US)

(21) Appl. No.: 13/092,961

(22) Filed: Apr. 24, 2011

Related U.S. Application Data
(60) Provisional application No. 61/327,268, filed on Apr. 23, 2010.

(51) Int. Cl. A47B 96/18; B32B 38/04

(52) U.S. Cl. 312/140.3; 156/256

(57) ABSTRACT

An improved countertop structure and method of manufacture thereof, said countertop structure having a laminate or composite horizontal upper surface and a laminate or composite vertical face with a front corner element adapted to form a contoured surface that smoothly fairs into both the upper surface and the face. The countertop is manufactured by first mounting a piece of solid surface sheet material to a plurality of elongated structural elements extending the length of said sheet and having thermal expansion compensation slots, the structural elements being strategically placed and adhered to the bottom surface of the solid surface sheet material to permit cutting to the desired width while providing the required structural support. The solid surface is bonded to the front vertical laminate surface and the front structural element to create a joined edge piece firmly attached to said sheet and said front structural element. The joined front edge piece and sheet is finished to the desired contour. The surface is then cut to the desired width and installed.

### BACKGROUND AND SUMMARY OF THE INVENTION

This invention relates to countertops, and in particular to a modular construction which is useful in constructing countertops of various widths and which have integral structural elements.

Countertops such as kitchen counters, tables, furniture and the like, generally consist of a horizontal work surface and a front vertical surface or face, frequently having a bevelled, rounded, ogee or “bullnose” shape. When man made solid surface materials, such as CORIAN® or similar sheet materials are used on both the horizontal upper surface and the vertical frontal face of countertops there are difficulties in joining these horizontal and vertical surfaces, particularly in field installation conditions. Traditionally there has been a sharp right angle corner between the horizontal and vertical surface. Because of its sharpness, this corner is easily damaged when it is hit and when damaged it is difficult to repair. A sharp right angle corner is not as aesthetically pleasing as a beveled or rounded corner in most countertop applications.

Traditionally, either laminate or sheet material countertop elements have been directly attached to the structural framework of the cabinet to which it is being installed. Differences in the thermal expansion of the laminate or sheet material with the structural framework has in some instances caused problems in the attachment as well as uneven surfaces.

Methods of installing an aesthetically pleasing countertop include the methods of U.S. Pat. Nos. 5,310,435, and 6,183,585 to Kelley, (Kelley patents). The Kelley patents involve the placement of a component of solid surface, such as is commonly sold under the trademark name CORIAN®, into notches in an edge piece of countertop, then finishing the surfaces to a desired radius to form a rounded edge.

This system requires cutting solid surface material such as CORIAN® to a rounded edge while this material is affixed to a laminate surface. Laminate surfaces as are commonly found in countertops often have a very thin color layer. Cuts or abrasions easily penetrate this color layer revealing what is often a dark underlayer. This results in significant waste and loss of time as the entire solid surface and laminate component having such defects must be repaired or discarded.

Solid surface materials also tend to be very expensive. It is desirable to have a method of manufacturing rounded edge countertops for various width applications that uses minimal amounts of solid surface material and which can be easily prepared in the field for varying width applications, while maintaining excellent structural and thermal expansion properties.

Other problems with the known prior art include the difficulty bonding or gluing solid surface materials to other surfaces. Solid surface materials commonly used in countertops by their nature are minimally porous and resistant to binding to prevent staining and facilitate cleaning. While these materials may be glued, they often require specialized glues and extended set time and clamping. Differences in thermal expansion often cause problems in attaching the solid sheet materials to the supporting structural elements.

### SUMMARY OF THE INVENTION

The subject invention overcomes the foregoing shortcomings and limitations of laminate and veneer countertops by providing an improved method for manufacture of a modular top surface element which can be cut to the desired width for standard and non standard width countertops and mantle applications and which has integrally installed structural elements having means to accommodate different rates of thermal expansion in the elements used in the factory manufacture of the countertop modules. A solid surface corner element is located at the front edge of the solid surface sheet, with adequate depth to accommodate an arcuate or radiused finished front surface with a substantially invisible joint. Structural elements with provision to accommodate thermal expansion are firmly attached to the bottom surface of the solid sheet and extend the length of the solid sheet material used in the manufacture of the countertop module.

The specific improvements of the present invention relate to the finishing of the solid surface front corner element after bonding to the solid sheet, permitting the radiused or other surface to be finished as desired without compromising the structure. Further improvements over the prior art include the ability to utilize the module in varying counter widths with factory installed structural elements to mitigate thermal expansion problems.

Accordingly, it is a principal object of the present invention to provide for the improved manufacture of a countertop module having a solid surface top surface, structural elements adhered to said sheet and vertical front edge face integrally formed said module available for field configuration into countertops of various widths.

It is a further object of the subject invention to provide a countertop module capable of use with varying width applications and having integral, factory installed structural elements having thermal expansion accommodating means therein.

A still further object of this invention is to provide a method of manufacturing a countertop module having integral structuralo elements which may be sized to fit an application in the field and provide structural integrity when installed.

The foregoing and other objectives, features and advantages of the present invention will be more readily understood upon consideration of the following detailed description of the invention taken in conjunction with the accompanying drawings.

### BRIEF DESCRIPTION OF THE DRAWINGS

FIGS. 1 AND 2 are a series of perspective views showing the structure and configuration of the countertop module;

FIG. 1a is a partial cross section taken along lines a-a of FIG. 1;

FIG. 3 is a perspective view of the upper surface of a full width configuration showing the finished edge piece of the countertop;

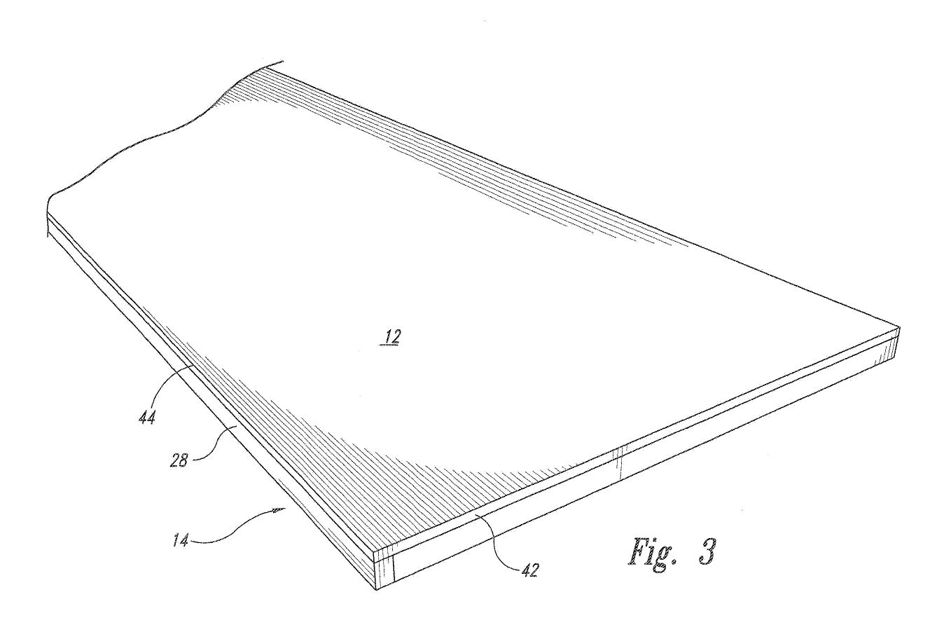

FIG. 4 is a bottom perspective view of a countertop module embodying the subject invention and showing the relative locations of the structural elements;

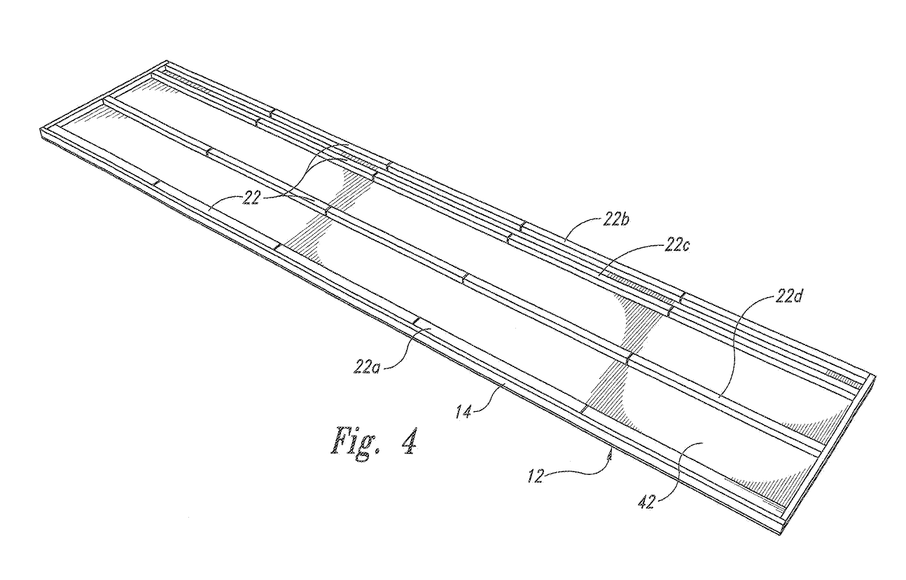

FIG. 5 is a bottom perspective view of a portion of the device of this invention cut for use as a narrow mantle piece or other narrow countertop.

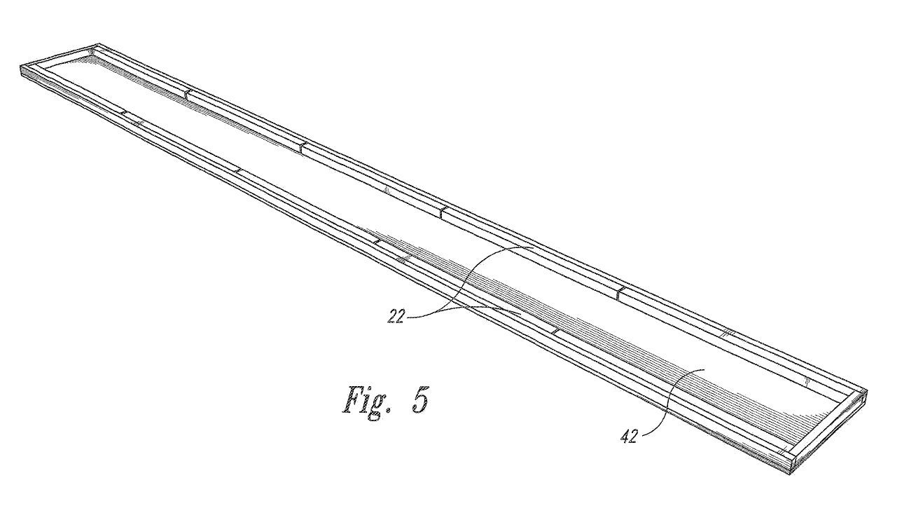

### PREFERRED EMBODIMENT OF THE INVENTION

Countertops of this type are commonly used on kitchen cabinets and similar structures. However, the invention can also be utilized with decks made from veneer covered wood or similar materials, such as is used on tables, desks, and other furniture items.

Referring to the drawings, the various components involved with the method of the invention retain their indicators throughout the figures. The invention relates to the process of finishing a horizontal surface 12 with an exposed vertical edge 14 having a vertical edge 28 and a solid surface corner element 44 which may be beveled or rounded into the desired contoured shape.

The horizontal surface 12 in most countertops such as will be utilized with the invention are comprised of a composite sheet, such as CORIAN®, securely mounted on a specially configured structural bases 22 of elongated wood or wood substitute. The structural elements forming the base are located strategically so that the sheet may be cut in widths to form the desired countertop and have the structural elements positioned at locations across the underside of the sheet to properly support the sheet and to mate with the underlying structure formed to receive the countertop.

Generally the finished surface is bounded at least on the front exposed surface by vertical edges 28 of the base suitably contoured as noted above.

Referring to the drawings, a length of solid sheet surface component 42 such as thermoplastic material of the type sold under the trademark CORIAN is affixed to a plurality of wood or wood substitute structural beam elements 22. A front edge sheet 28 of CORIAN® or other sheet material is attached to the lower front edge of sheet 42 and structural element 22a as shown. The desired curved edge is then is fabricated by finishing an arc or other desired shape into the upper surface of a solid surface component 42, forming a beveled or arcuate solid surface component 44 with a desired exposed shape. This solid surface component 44 may be formed by any number of shaper means, including but not limited to high speed rotating blades such as are commonly used in routers.

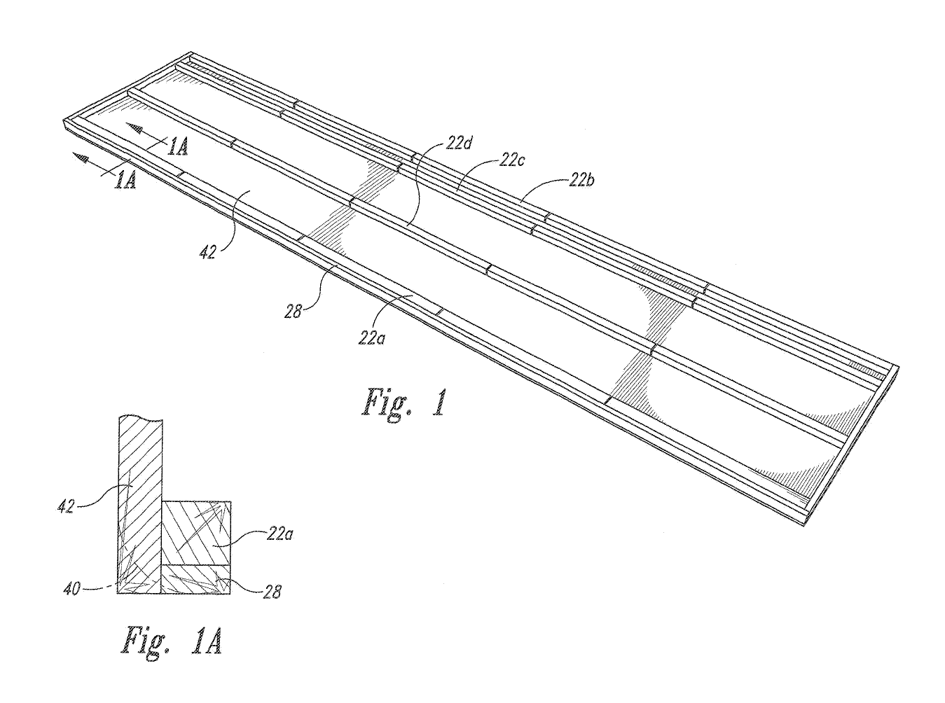

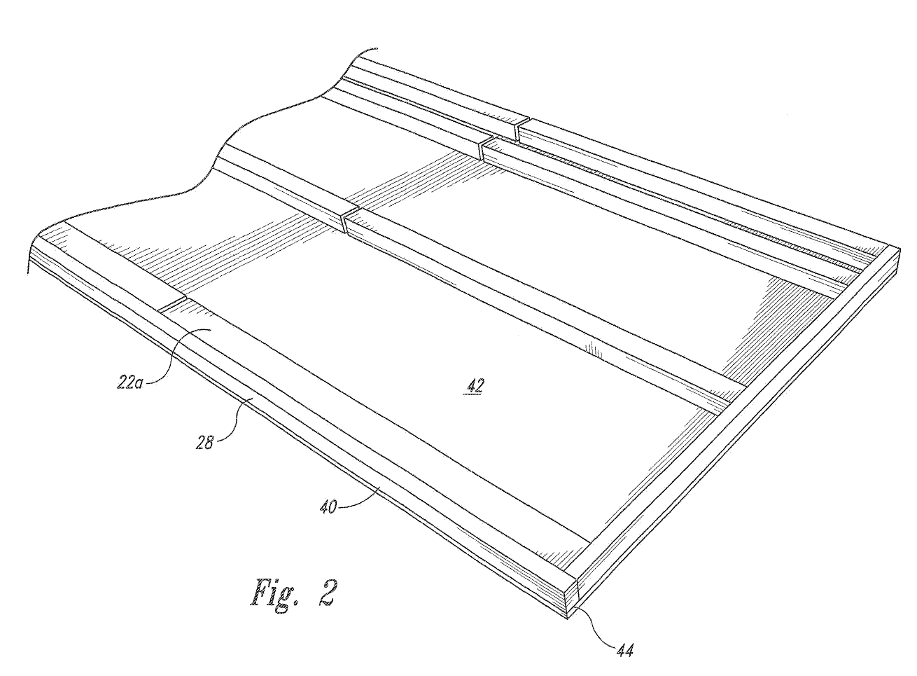

The outermost structural element 22a is made from an elongate rectangular cross-sectioned block of wood or wood substitute substrate which has approximately the same height as the edge piece 28. As is best seen in FIGS. 1a and 2, the edge piece 28 is attached to one side of the structural element 22a and adhered to the lower surface of surface component 42, to provide the outside or finished surface. The edge may be milled or cut to a desired shape or angle, to form a contoured face 40.

The arcuate solid surface component 44, is affixed to the beveled angle face 40 to form the joined edge piece 24. The surfaces are aligned and secured by means such as glue. Solid surface composite or thermoplastic material requires special care when gluing, often require special glues and increased bond times. Permitting two wood type surfaces 22, 36 to be joined in the bond greatly facilitates and speeds assembly. Special care should be taken to avoid the effects of various rates of thermal expansion between the composite or thermoplastic material and the structural elements used to support and strengthen the countertop module.

The back side of the edge piece 24 and the overhanging portions of the solid surface component 44 and backer 22 are cut to form a finished end piece 24 that is to be affixed to the exposed vertical edge of the horizontal composite or laminate work surface 12.

Alternate embodiments of this invention may include a contoured facing surface on both front and back of the sheet so that two countertop surfaces suitable for use in different applications may be obtained from a single sheet.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A method for forming a countertop comprising:
(a) placing and adhering a composite or laminate sheet on elongated structural elements disposed at intervals beneath the sheet;
(b) placing and adhering a composite or laminate strip along the lower exposed face side of said sheet, said strip having a length substantially equal to the length of said sheet, and;
(c) cutting the desired width from said sheet to form the countertop.

2. The method of claim 1 further including the additional step of forming a beveled or arcuate surface on a solid surface component having a length substantially equal to the length of said substrate.

3. The method of claim 1 further including the additional step of finishing said joined edge piece to form a front exposed surface.

4. The method of claim 1 further including the additional step of attaching said finished edge piece to said horizontal work surface forming an integral corner element between said horizontal work surface and said composite or laminate strip on the face side of said substrate material.

5. The method of claim 1 wherein one of said structural elements is positioned near said face side of said sheet and wherein said strip is adhered to said face side and said one of said structural elements.

6. The method of claim 1 and the step of providing transverse cuts in said structural elements to provide thermal expansion accommodating means in said structural elements.

7. A modular countertop structure for forming full width countertops, narrow countertops and narrow mantle structures comprising:
(a) a sheet of composite or laminar material suitable for forming the upper surface of a countertop, said sheet having an upper surface, an underside and a front edge:
(b) elongated structural elements spaced apart and adhered to the undersurface of said sheet, said structural elements spaced apart to support countertops cut from said sheet, each of said structural elements having thermal expansion accommodation means cut therein at intervals; and,
(c) front solid surface component adhesively attached to said underside of said sheet at said front edge thereof and to a front located structural element to form the exposed front edge of said countertop.

8. The modular countertop structure of claim 6 wherein said elongated structural elements extend along the length of said sheet and are positioned to provide support for said sheet when said sheet is cut to width.

9. The modular countertop structure of claim 6 wherein said thermal expansion accommodation means comprises transverse cuts in said structural elements.

10. The modular countertop structure of claim 6 wherein a second exposed edge, formed as said front edge, is positioned at the rear edge of said countertop structure enabling two countertops of various widths to be obtained from a single modular countertop structure by severing it lengthwise at the desired widths.
